(19) United States
(12) Patent Application Publication
(10) Pub. No.: US 2008/0196637 A1
(43) Pub. Date: Aug. 21, 2008

(54) Interactive safe for vehicles

(76) Inventors: Harry Michael Howell, San Marcos, CA (US); Michael Wayne Howell, San Marcos, CA (US)

Correspondence Address: HARRY MICHAEL HOWELL, 862 ANTILLA WAY, SAN MARCOS, CA, 92078, US

(21) Appl. No.: 12/009,748

(22) Filed: Jan. 22, 2008

Related U.S. Application Data
(60) Provisional application No. 60/902,482, filed on Feb. 21, 2007.

(51) Int. Cl. E05G 1/10

(52) U.S. Cl. 109/38

(57) ABSTRACT

An interactive safe that can be permanently attached to a vehicle is any location; it is capable of holding different items, designed in various shapes and sizes, customizable to interact with car manufacturers, and can be placed in various locations in a vehicle; the built-in electronic system may be connected to the vehicle's computer system, alarm system, or power source.

### FIELD OF THE INVENTION

The present invention relates generally to a safe that can be permanently installed in vehicles, and specifically to cars, trucks, vans, buses and other transportation vehicles, in which the safe is permanently installed inside the vehicle and connected via wires for power supply and the vehicle's security system. The safe has an inner box that is removable for owners to carry personal items such as jewelry, money, laptop, valuable items, and the like to and from the vehicle.

### BACKGROUND OF THE INVENTION

Virtually every car offers a secure method for owners and passengers to securely store items in a vehicle. Compartments such as glove box, center console, under-seat box, and trunks are areas in a vehicle where personal items can be locked up. Many times these areas are targeted by thieves. Although automakers have attempted to allow car owners to store items securely, there needs to be an improvement. Thieves have been able to find ways to break into a vehicle and take items even when they have been locked up.

By placing an electronic safe that has been permanently attached to the vehicle that can be wired into the car's computer/alarm system, it will deter thieves from trying to break into the safe. The electronic safe may also have built-in-alarm system. The safe may also be fireproof, waterproof, and lined on the inside to prevent damage to items.

### SUMMARY OF THE INVENTION

Disclosed herein is a mechanism and system for securing personal items in a vehicle. With the increase of theft from automobiles, there is a need for added security. Many times, personal items are hidden, placed in compartments, or locked in glove compartments. When the vehicle is burglarized, there's a good chance that the items are stolen. When the car does have an alarm system, there are times when the vehicle is broken into the items are taken without any notification. By having a safe in the vehicle that can be permanently installed, with an interactive security system, it gives owners peace-of-mind. Knowing that there's a possibility that most items of value are in a safe, it should deter thieves. The safe will meet safety device standards and should will fireproof, waterproof and the like.

### BRIEF DESCRIPTION OF THE INVENTION

FIG. 1 Elevation view of bottom half is safe presenting the present invention showing the insulation on the surrounding walls in the safe, made of non-flammable material, 2 is showing heat baffle in walls to make the safe fire resistant, 3 is showing wire mesh in walls for stability and to hold fire insulation, 4 showing four carriage bolts or rivets in the bottom of the safe. The bolts make the safe a permanent fixture that is attached to the inside of the vehicle. The safe can be attached to the vehicle in various locations at different angles, based on the vehicle's specifications.

FIG. 2 is view of the present invention showing 5 an electronic keypad to enter personal ID code to unlock safe, 6 shows electrical wires that runs under the bottom of the lid to electrical power box, 7 shows electrical lines out of the power box that is under the bottom of the lid of safe, 8 shows electrical lines that may be connected to the vehicle's power supply and security system, 9 shows darkened are that shows magnetic steel lining, that when the door/lid is closed, it locks the safe, if safe is tampered with, without entering the password, the internal or vehicle alarm is set off, 10 shows thickness of safe, safe thickness may vary, based on manufacturer's specification and/or vehicle's specifications. The dimensions, shape, and size may vary based on manufacturer's specification and/or vehicle's specification.

FIG. 3 is a view of the present invention 11 is an elevation view of the safe with the door/lid attached. Safe may be made from “Relsom Steel” which makes it a burglar-resistant safe. Relsom safe is a new metal that is bonded with a copper plate, which is torch-proof, drill-proof, and shatter-proof. The steel plate is ¼′ thickness, but thickness may vary. The safe may be made from different types of materials, based on manufacturer's specification and/or vehicle's specifications, 12 shows two of four carriage bolts that permanently attach the safe in the vehicle. The number of bolts may vary based on manufacturer's specification and/or vehicle's specifications. The safe may also be attached to the vehicle using methods such as welding, rivets and the like, based on manufacturer's specification, 13 shows two Relsom Steel hinges to open and close the safe, the number of hinges may vary based on manufacturer's specification and/or vehicle's specifications, 14 shows the thickness of the door/lid of the safe to be ¾′, door/lid thickness may vary, based on manufacturer's specification. The dimensions, shape, and size of the door/lid may vary based on manufacturer's specification and/or vehicie's specification.

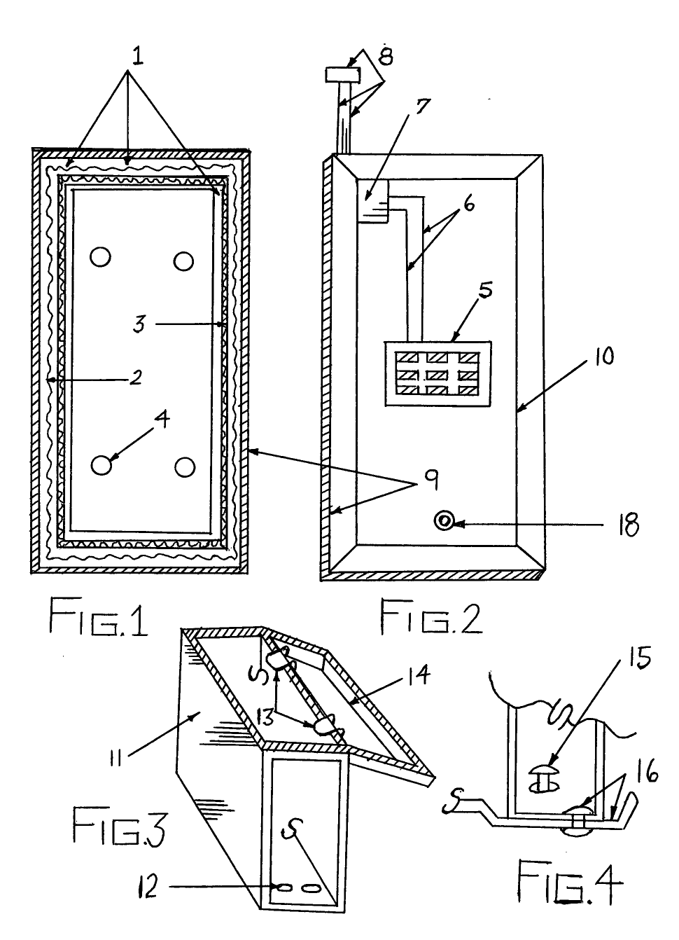

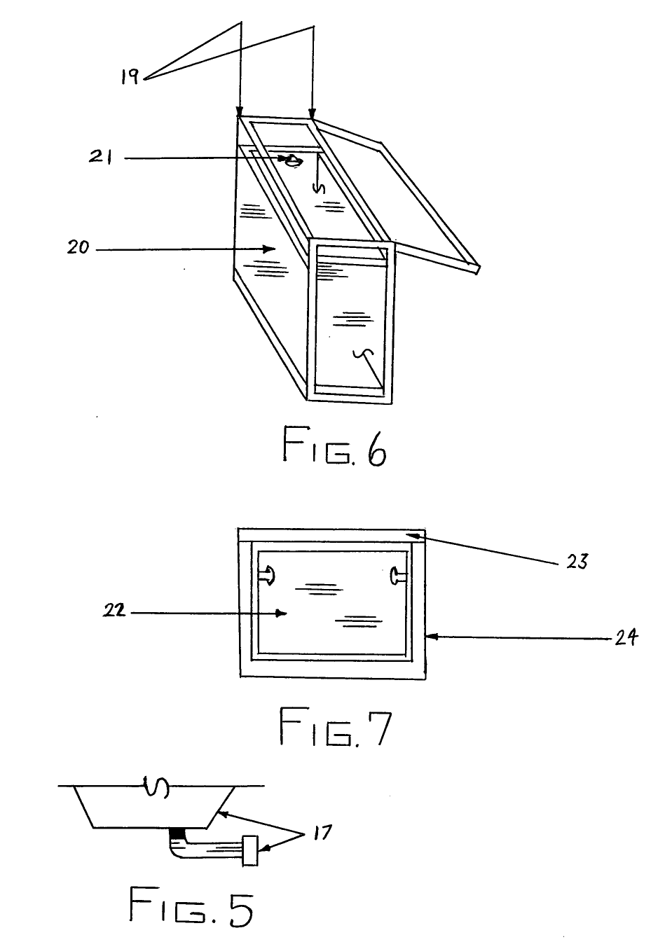

FIG. 4 is a cross-section view of the present invention 15 shows carriage bolt placed completely through bottom of steel plate. The placement of the carriage bolts, rivets, and the like, may vary, based on manufacturer's specification and/or vehicle's specifications, 16 shows carriage bolts connected to the frame of the vehicle. Bolts cannot be removed from the outside of the safe, meaning there should be access from within the safe to install or remove safe. The safe may be riveted, welded and the like to help prevent the safe from being removed from the vehicle. All means to attach safe to the vehicle, and a combination of these means may vary, based on manufacturer's specification and/or vehicle specification.

FIG. 5 is a view of the present invention 17 shows the continuation of “8” shows the electrical, and alarm wires that connects the safe to the vehicle power supply, computer system alarm system, and the like. Power supply may be provided b vehicle or batteries installed inside the safe, or a combination of the two, and the like. Power supply may vary, based on manufacturer's specification and/or vehicle's specifications. The location of the wires may vary, based on manufacturer's specification and/or vehicle's specifications 18 shows key lock in safe which may be used as another way to enter the safe due to loss of power.

FIG. 6 is the view of the present invention 19 shows the direction in which the inner metal box that has been installed in the safe. It is also made of “Relsom Steel” to help protect valuables. The metal box may or may not be part of the safe, 20 shows inner metal box inside the safe, 21 shows a knob fastened to the inner metal box o it can be removed out of the safe. This makes for valuables to be portable and carried with needed. The knob may be a handle, lever, and the like. The placement knob, handle, and the like may vary, based on manufacturer's specification and/or vehicle's specifications. The inner box may be made from different types of materials, based on manufacturer's specification and/or vehicle's specifications. The placement of the inner metal box may vary, based on manufacturer's specification and/or vehicle's specifications.

FIG. 7 is a side view of the present invention 22 shows the metal box inside the safe, 23 shows the door/lid of the safe when closed and secured, 24 shows the safe with Relsom Steel with the inner box inside.

### DETAILED DESCRIPTION OF THE INVENTION

The present invention provides a method for people to secure personal items in a vehicle. It allows people to place valuable belongings in a place that is protected in a vehicle. Most items in vehicles are vulnerable to theft or damage since the current methods of locking items up are not fully protected. The present invention provides a make safe means to lock up valuable items that can only retrieved by the owner. It should lesson the possibility of vehicles being broken into. Even if a car is burglarized, most thieves want to act quickly by grabbing as many items as possible in a short amount of time. By placing the valuables in a safe, most thieves will not have the knowledge or tools necessary to break into a safe. By having a built-in alarm or being connected to the vehicle's alarm system, it's a great deterrent. The electronic entry system only allows authorized users. There may also be a key available for owners if the password has been lost or forgotten. The safe may be wired to the vehicle for power supply and/or have batteries. The present invention provides vehicle owners to have a secure place for valuables and also provides a way to transport items. The inner box will allow a portable means for transport that can be quickly placed into the safe in the vehicle.

We claim:

1. I, Harry M. Howell and Michael W. Howell, claim as our invention is an interactive safe for vehicles that can be installed during manufacturing of the vehicle or as an after-market item that will allow people to store valuable items in their vehicle; the safe may be connected to the vehicle's power source, computer system, and/or alarm system; the safe can be customized to meet manufacturer's specification or can be designed to be installed post-production of the vehicle; the safe can be permanently installed and have the ability to be connected to any type of vehicle; the safe has a removable inner-lining that can be taken out of the safe at the owner's convenience; the removable inner-lining may or may not have a lock for additional security.
